(19) United States
(12) Patent Application Publication
(10) Pub. No.: US 2019/0230201 A1
(43) Pub. Date: Jul. 25, 2019

(54) APPARATUS AND METHOD FOR CONTINUOUS AND CROSS-MEDIA TRANSMISSION OF COMMUNICATION PROTOCOLS WITHOUT PROTOCOL CONVERSION

(71) Applicant: Fraunhofer-Gesellschaft zur Foerderung der angewandten Forschung e.V., Munich (DE)

(72) Inventors: Andreas OEDER, Erlangen (DE); Matthias KLATT, Erlangen (DE); Moritz LOSKE, Erlangen (DE)

(21) Appl. No.: 16/368,751

(22) Filed: Mar. 28, 2019

Related U.S. Application Data
(63) Continuation of application No. PCT/EP2017/074054, filed on Sep. 22, 2017.

(30) Foreign Application Priority Data
Sep. 28, 2016 (DE) 10 2016 218 758.9

(51) Int. Cl. H04L 29/08; H04L 29/06; H04L 12/66; H04L 1/00

(52) U.S. Cl. CPC H04L 69/326; H04L 69/18; H04L 1/0045; H04L 12/66; H04L 69/22

(57) ABSTRACT

An apparatus for forwarding a payload data field from a first communication network into a second communication network is provided. The apparatus includes a first interface that is configured to receive a data packet from the first communication network, wherein the data packet includes a data packet header and the payload data field, wherein the data packet header includes a type field. Further, the apparatus includes a second interface that is configured to transmit the payload data field via the second communication network when the type field includes a data value differing from a first data value. The second interface is configured to not transmit the payload data field via the second communication network when the type field includes the first data value.

### CROSS-REFERENCE TO RELATED APPLICATIONS

This application is a continuation of copending International Application No. PCT/EP2017/074054, filed Sep. 22, 2017, which is incorporated herein by reference in its entirety, and additionally claims priority from German Application No. 10 2016 218 758.9, filed Sep. 28, 2019, which is also incorporated herein by reference in its entirety.

The application relates to data transmission, in particular data transmission via different communication media and more particularly an apparatus and method for continuous and cross-media transmission of communication protocols without protocol conversion.

### BACKGROUND OF THE INVENTION

Data transmission via different communication media has different strengths and weaknesses. First, the following basic communication media for data transmission can be distinguished:

On the one hand, there is wire-bound data transmission without carrier modulation via copper cable. The following will be referred to as wired communication below.

Further, there is wire-bound data transmission with carrier modulation via an optical waveguide.

On the other hand, there is radio-based data transmission, which will be referred to below as wireless communication.

Wireless and wired data transmissions have different strengths and weaknesses:

The range and reliability of wireless data transmission depends on the environment. Obstacles, such as walls, metal poles or a large machine/industry plant can affect the propagation of radio waves. Wired communication, however, is (mostly) independent of the environment and structural particularities. The range of radio technologies is frequently very limited, in particular within buildings.

Different transmitters within a region interfere with each other. Only a single wireless transmitter can transmit a message at one frequency within a region at a time. The number of wired networks, however, within a region is not limited by other users or interferences, since it is possible (when corresponding good shielding is assumed) to lay different lines in close proximity.

A great disadvantage of wired communication compared to wireless communication is that laying of a cable is needed for wired transmission.

For that reason, depending on the field of application and the environment, different wired and wireless communication standards and communication protocols are frequently used in parallel and in combination.

Here, the technical problem is the realization of the cross-media information exchange without needing expensive protocol conversion between wired and wireless communication. So far, direct cross-media communication and addressing a communication node is not possible in this way. As a consequence, cross-media and continuous Layer2 encryption (link layer/MAC layer) is not possible.

So far, the media change from wired to wireless data transmission is realized by a gateway or a bridge by means of protocol conversion. Here, conversion of protocols can extend to different layers of the ISO/OSI model.

For example, a ZigBee gateway from Ethernet to ZigBee from conventional technology (see https://arxiv.org/ftp/arxiv/papers/1002/1002.1146.pdf) can be considered.

Numerous conventional technology references exist for the IEEE 802.15.4 gateway.

Interconnection of 802.15.4 devices and the effects regarding IPv6 and to existing approaches is described, for example, in conventional technology, see https://arxiv.org/ftp/arxiv/papers/1002/1002.1146.pdf.

Concerning TCP/IP via IEEE 802.15.4 a representation can be found at http://ihomelab.ch/fileadmin/Dateien/PDF/FHLuzern_TCPIPoverIEEE8022015204.pdf.

An IEEE 802.15.4/ZigBee to IEEE 802.11 gateway for the ART-WiSe architecture is described at https://www.researchgate.net/publication/224299487_On_a_IEEE_802154ZigBee_ to _IEEE_80211_gateway_for_the_ART-WiSe₁₃ architecture.

The IEEE standard 802.15.4-2006: Wireless Medium Access Control (MAC) and Physical Layer (PHY) Specifications for Low-Rate Wireless Personal Area Networks (LR-WPANs) can be found at http://standards.ieee.org/getieee802/download/802.15.4-2006.pdf.

For transmitting IPv6 packets via IEEE 802.15.4 networks, see http://tools.ietf.org/html/rfc4944.

Regarding the compression format for IPv6 packets via IEEE 802.15.4 based networks see http://tools.ietf.org/html/rfc6282.

### SUMMARY

According to an embodiment, an apparatus for forwarding a payload data field from a first communication network into a second communication network may have: a first interface that is configured to receive a data packet from the first communication network, wherein the data packet includes a data packet header and a payload data field, wherein the data packet header includes a type field and a second interface that is configured to transmit the payload data field via the second communication network when the type field includes a data value differing from a first data value and wherein the second interface is configured to not transmit the payload data field via the second communication network when the type field includes the first data value.

According to another embodiment, an apparatus for generating and transmitting a data packet may have: a generating unit that is configured to generate the data packet such that the data packet includes a data packet header and a payload data field, wherein the data packet header includes a type field and an interface that is configured to transmit the data packet via a first communication network to a receiving apparatus, wherein the generating unit is configured to generate the data packet such that the type field includes a first data value when the payload data field of the data packet is not to be transmitted by the receiving apparatus via a second communication network and wherein the generating unit is configured to generate the data packet such that the type field includes a data value differing from the first data value when the payload data field of the data packet is to be transmitted by the receiving apparatus via the second communication network.

According to another embodiment, a system for generating and transmitting a data packet via a first communication network and for forwarding a payload data field of the data packet from the first communication network into a second communication network may have: an inventive apparatus for generating and transmitting a data packet, for generating the data packet and an inventive apparatus for forwarding the payload data field of the data packet via the second communication network, wherein the apparatus for generating and transmitting a data packet is configured to transmit the data packet via the first communication network to the inventive apparatus for forwarding, wherein the apparatus for forwarding is configured to receive the data packet from the apparatus for generating and transmitting a data packet, wherein the apparatus for forwarding is configured to transmit the payload data field via the second communication network when a type field of a data packet header of the data packet includes a data value differing from a first data value and wherein the apparatus for forwarding is configured to not transmit the payload data field via the second communication network when the type field of the data packet header of the data packet includes the first data value.

According to another embodiment, a data packet for transmitting a payload data field via a first communication network to a receiving apparatus may have: a data packet header and the payload data field, wherein the data packet header includes a type field and wherein the type field includes a first data value when the payload data field of the data packet is not to be transmitted by the receiving apparatus via a second communication network and wherein the type field includes a data value differing from the first data value when the payload data field of the data packet is to be transmitted by the receiving apparatus via the second communication network.

According to another embodiment, a method for forwarding a payload data field from a first communication network into a second communication network may have the steps of: receiving a data packet from the first communication network, wherein the data packet includes a data packet header and the payload data field, wherein the data packet header includes a type field, transmitting the payload data field via the second communication network when the type field includes a data value differing from a first data value and no transmitting of the payload data field via the second communication network when the type field includes the first data value.

According to another embodiment, a method for generating and transmitting a data packet may have the steps of: generating the data packet such that the data packet includes a data packet header and a payload data field, wherein the data packet header includes a type field and transmitting the data packet via a first communication network to a receiving apparatus, wherein the data packet is generated such that the type field includes a first data value when the payload data field of the data packet is not to be transmitted by the receiving apparatus via a second communication network and wherein the data packet is generated such that the type field includes a data value differing from the first data value when the payload data field of the data packet is to be transmitted by the receiving apparatus via the second communication network.

Another embodiment may have a non-transitory digital storage medium having a computer program stored thereon to perform the method for forwarding a payload data field from a first communication network into a second communication network, the method having the steps of: receiving a data packet from the first communication network, wherein the data packet includes a data packet header and the payload data field, wherein the data packet header includes a type field, transmitting the payload data field via the second communication network when the type field includes a data value differing from a first data value and no transmitting of the payload data field via the second communication network when the type field includes the first data value, when said computer program is run by a computer.

Another embodiment may have a non-transitory digital storage medium having a computer program stored thereon to perform the method for generating and transmitting a data packet, the method having the steps of: generating the data packet such that the data packet includes a data packet header and a payload data field, wherein the data packet header includes a type field and transmitting the data packet via a first communication network to a receiving apparatus, wherein the data packet is generated such that the type field includes a first data value when the payload data field of the data packet is not to be transmitted by the receiving apparatus via a second communication network and wherein the data packet is generated such that the type field includes a data value differing from the first data value when the payload data field of the data packet is to be transmitted by the receiving apparatus via the second communication network, when said computer program is run by a computer.

An apparatus for forwarding a payload data field from a first communication network into a second communication network is provided. The apparatus includes a first interface that is configured to receive a data packet from the first communication network, wherein the data packet includes a data packet header and the payload data field, wherein the data packet header comprises a type field. Further, the apparatus comprises a second interface that is configured to transmit the payload data field via the second communication network when the type field comprises a data value differing from the first data value. The second interface is configured to not transmit the payload data field via the second communication network when the type field comprises the first data value.

Further, an apparatus for generating and transmitting a data packet is provided. The apparatus includes a generating unit that is configured to generate the data packet, such that the data packet includes a data packet header and the payload data field, wherein the data packet header comprises a type field. Further, the apparatus comprises an interface that is configured to transmit the data packet to a receiving apparatus via a first communication network. The generating unit is configured to generate the data packet such that the type field comprises a first data value when the payload data field of the data packet is not to be transmitted by the receiving apparatus via a second communication network. Further, the generating unit is configured to generate the data packet such that the type field comprises a data value differing from the first data value when the payload data field of the data packet is to be transmitted by the receiving apparatus via the second communication network.

Further, a system for generating and transmitting a data packet via a first communication network and for forwarding a payload data field of the data packet from the first communication network into a second communication network is provided. The system includes one of the above described apparatuses for generating and transmitting a data packet for generating the data packet and one of the above described apparatuses for forwarding the payload data field from a first communication network into a second communication network. The apparatus for generating and transmitting a data packet is configured to transmit the data packet via the first communication network to the apparatus for forwarding a payload data field from a first communication network into a second communication network. Further, the apparatus for forwarding a payload data field from a first communication network into a second communication network is configured to receive the data packet from the apparatus for generating and transmitting a data packet. The apparatus for forwarding a payload data field from a first communication network into a second communication network is configured to transmit the payload data field via the second communication network when a type field of a data packet header of the data packet comprises a data value differing from a first data value. Further, the apparatus for forwarding a payload data field from a first communication network into a second communication network is configured to not transmit the payload data field via the second communication network when the type field of the data packet header of the data packet comprises the first data value.

Further, a data packet for transmitting a payload data field via a first communication network to a receiving apparatus is provided. The data packet includes a data packet header and the payload data field. The data packet header comprises a type field. The type field comprises a first data value when the payload data field of the data packet is not to be transmitted by the receiving apparatus via a second communication network. The type field comprises a data value differing from the first data value when the payload data field of the data packet is to be transmitted by the receiving apparatus via the second communication network.

Further, a method for forwarding a payload data field from a first communication network into a second communication network is provided, the method comprising:
receiving a data packet from the first communication network, wherein the data packet comprises a data packet header and the payload data field, wherein the data packet header comprises a type field and
transmitting the payload data field via the second communication network when the type field comprises a data value differing from a first data value and no transmitting of the payload data field via the second communication network when the type field comprises the first data value.

Further, a method for generating and transmitting a data packet is provided. The method comprises:
generating the data packet, such that the data packet comprises a data packet header and a payload data field, wherein the data packet header comprises a type field and
transmitting the data packet via a first communication network to a receiving apparatus.

Here, the data packet is generated such that the type field comprises a first data value when the payload data field of the data packet is not to be transmitted by the receiving apparatus via a second communication network and

further, the data packet is generated such that the type field comprises a data value differing from the first data value when the payload data field of the data packet is to be transmitted by the receiving apparatus via the second communication network.

Further, computer programs having a program code for performing the above-described methods are provided when the computer program is executed on a computer or a signal processer.

### BRIEF DESCRIPTION OF THE DRAWINGS

Embodiments of the present invention will be detailed subsequently referring to the appended drawings, in which:

FIG. 1 shows an apparatus for forwarding a payload data field from a first communication network into a second communication network according to an embodiment;

FIG. 2 shows an apparatus 200 for generating and transmitting a data packet according to an embodiment;

FIG. 3 shows a system for generating and transmitting a data packet via a first communication network and for forwarding a payload data field of the data packet from the first communication network into a second communication network according to an embodiment;

FIG. 4 shows a system according to an embodiment further comprising a receiving unit;

FIG. 5 shows a data packet according to a first embodiment;

FIG. 6 shows a data packet according to a second embodiment;

FIG. 7 shows a data packet according to a third embodiment;

FIG. 8 shows a data packet according to a fourth embodiment;

FIG. 9 shows a layer model for an IoT bus according to an embodiment; and

FIG. 10 shows a communication structure according to an embodiment.

### DETAILED DESCRIPTION OF THE INVENTION

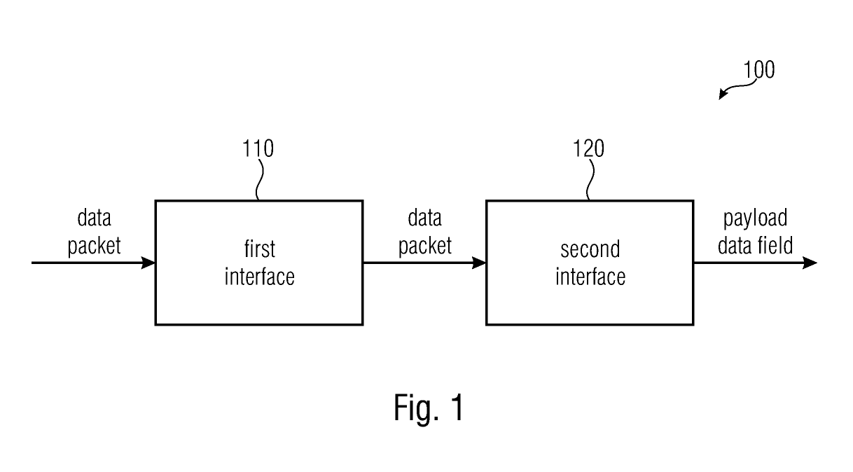

FIG. 1 shows an apparatus 100 for forwarding a payload data field from a first communication network into a second communication network according to an embodiment.

The apparatus 100 includes a first interface 110 that is configured to receive a data packet from the first communication network, wherein the data packet includes a data packet header and the payload data field, wherein the data packet header comprises a type field.

Further, the apparatus 100 includes a second interface 120 that is configured to transmit the payload data field via the second communication network when the type field comprises a data value differing from a first data value. The second interface 120 is configured to not transmit the payload data field via the second communication network when the type field comprises the first data value.

Here, the type field can, for example, be communication network specific. Thus, this type field can indicate, for example information concerning the used data packet type (frame type). Based on the used frame type, it can be determined whether it is, for example a data packet (a frame) for application-specific data transmission (e.g. temperature values of a sensor) or a data packet (a frame) for managing the first communication network. Thus, for example, frames for application-specific data transmission can be freely exchanged between the first and the second communication network. For example, in specific embodiments, data packets/frames for managing the first communication network are only forwarded within the first communication network but not into the second communication network.

According to an embodiment, the first interface 110 can be configured, e.g., to receive the data packet from the first communication network, wherein the first communication network is a wired communication network. Here, when the type field comprises a data value differing from the first data value, the second interface 120 can be configured to transmit the payload data field via the second communication network, wherein the second communication network is a wireless communication network. Further, when the type field comprises the first data value, the second interface 120 can be configured to not transmit the payload data field via the wireless communication network.

In one embodiment, when the type field comprises the first data value, the data packet can be a data packet for managing the first communication network, wherein the second interface 120 can be configured to not transmit the data packet via the second communication network when the data packet is a data packet for managing the first communication network.

According to one embodiment, the type field of the data packet header can include exactly one bit. Here, when the type field comprises a second data value differing from the first data value, the second interface 120 can be configured to transmit the payload data field via the second communication network. Further, when the type field comprises the first data value, the second interface 120 can be configured to not transmit the payload data field via the second communication network.

In an alternative embodiment, the type field of the data packet header can include more than one bit. Here, the second interface 120 can be configured to transmit the payload data field via the second communication network when the type field comprises one of three or more data values differing from the first data value. Further, the second interface 120 can be configured to not transmit the payload data field via the second communication network when the type field comprises the first data value.

According to one embodiment, the data packet is a received data packet, wherein the data packet header of the received data packet can comprise a media-dependent part and a media-independent part, wherein the media-dependent part comprises the type field. Further, when the type field comprises a data value differing from the first data value, the second interface 120 can be configured to form a converted data packet and to transmit the same via the second communication network, wherein the converted data packet includes the media-independent part of the data packet header of the received data packet and the payload data field of the received data packet, but not the media-dependent part of the data packet header of the received data packet.

In one embodiment, the received data packet can further include one or several check bits. Here, when the type field comprises a data value differing from the first data value, the second interface 120 can be configured to form, the converted data packet such that the converted data packet includes the one or several check bits of the received data packet as one or several check bits of the converted data packet without changing the value of the one or several check bits in the converted data packet compared to the one or several check bits of the received data packet.

According to one embodiment, the one or several check bits of the received data packet are one or several received check bits, wherein the first interface 110 can be configured to determine one or several determined check bits. Here, the first interface 110 can be configured to determine the one or several determined check bits based on the media-independent part of the data packet header of the received data packet and based on the payload data field of the received data packet but not based on the media-dependent part of the data packet header of the received data packet. Further, the first interface 110 can be configured to compare the one or several determined check bits to the one or several received check bits to check the received data packet for errors.

This has the advantage that the media-dependent part of the data packet header can be removed when switching from the first communication network into the second communication network without having to change the check bits, since the same relate only to the media- independent part of the data packet header and the payload data field but not to the media-dependent part of the data packet header.

In one embodiment, the first interface 110 can be configured to transfer the received data packet to the second interface 120 when the one or several received check bits correspond to the one or several determined check bits. Further, the first interface 110 can be configured to not transfer the received data packet to the second interface 120 when the one or several received check bits do not correspond to the one or several determined check bits.

In one embodiment, the payload data field of the received data packet can be an encrypted payload data field provided in encrypted form. Here, when the type field comprises a data value differing from the first data value, the second interface 120 can be configured to form the converted data packet without decrypting the encrypted payload data field, such that the converted data packet includes the encrypted data field. Therefore, decrypting and renewed encrypting of the payload data field is not needed.

According to one embodiment, the media-independent part of the data packet header can be an encrypted media-independent part of the data packet header provided in encrypted form. When the type field comprises a data value differing from the first data value, the second interface 120 can be configured to decrypt the encrypted media-independent part of the data packet header to obtain decrypted header information including a target address, further to form the converted data packet such that the converted data packet comprises the encrypted media-independent part of the data packet header without encrypting the decrypted header information again and further to transmit, in dependence on the target address, the converted data packet via the second communication network to a target.

Thus, for example, the encrypted media-independent part of the data packet header can be decrypted to obtain the header information with the target address, for example by using a network key provided in the interface for decrypting. This network key can then be also provided in a plurality of further interfaces which then again decrypt the encrypted media-independent part of the data packet header in order to determine the target address. However, it is essential that there is no need to encrypt the decrypted media-independent part of the data packet header again. Instead, the encrypted media-independent part of the data packet header can be inserted again in the converted data packet in the same form as in the received data packet. This saves resources in the apparatus 100.

According to one embodiment, the media-independent part of the data packet header of the received data packet can be a network access layer header of a network access layer of the TCP/IP protocol stack (network access layer: the layer in the TCP/IP protocol stack directly below the IP layer). Here, when the type field comprises a data value differing from the first data value, the second interface 120 can be configured to form the converted data packet such that the converted data packet leaves the media-independent part of the data packet header of the received data packet as network access layer header of the network access layer of the TCP/IP protocol stack within the converted data packet. Or the media-independent part of the data packet header of the received data packet can be a data link layer of the ISO/OSI model protocol stack, wherein, when the type field comprises a data value differing from the first data value, the second interface 120 can be configured to form the converted data packet such that the converted data packet leaves the media-independent part of the data packet header of the received data packet as data link layer header of the data link layer of the ISO/OSI model protocol stack in the converted data packet.

In one embodiment, the media-independent part of the data packet header of the received data packet can be a data packet header according to IEEE 802.15.4. Here, when the type field comprises a data value differing from the first data value, the second interface 120 can be configured to form the converted data packet such that the converted data packet includes the media-independent part of the data packet header of the received data packet as a data packet header according to IEEE 802.15.4.

Further, according to one embodiment, the received data packet can comprise a further header which is a header of a physical layer of the ISO/OSI model protocol stack. Here, when the type field comprises a data value differing from the first data value, the second interface 120 can be configured to form the converted data packet such that the converted data packet again comprises a header of the physical layer of the ISO/OSI model protocol stack differing from the further header of the received data packet.

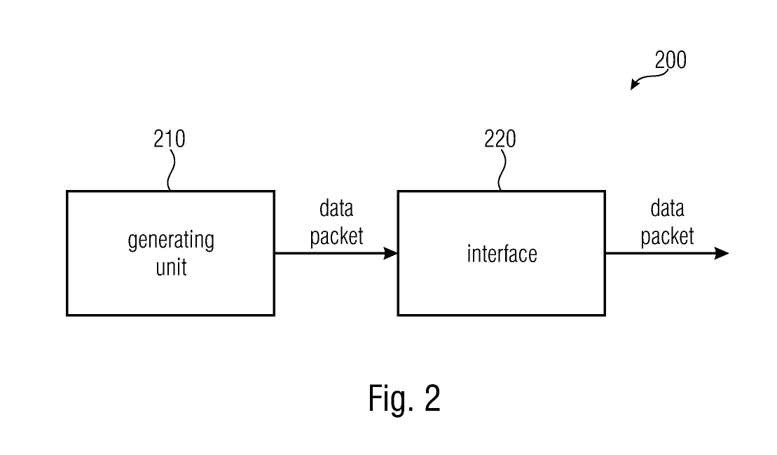

FIG. 2 shows an apparatus 200 for generating and transmitting a data packet according to one embodiment. The apparatus 200 includes a generating unit 210 that is configured to generate the data packet such that the data packet includes a data packet header and a payload data field, wherein the data packet header comprises a type field. Further, the apparatus 200 includes an interface 220 that is configured to transmit the data packet via a first communication network to a receiving apparatus 100 (not shown in FIG. 2). The generating unit 210 is configured to generate the data packet such that the type field comprises a first data value when the payload data field of the data packet is not to be transmitted by the receiving apparatus 100 via a second communication network. Further, the generating unit 210 is configured to generate the data packet such that the type field comprises a data value differing from the first data value when the payload data field of the data packet is to be transmitted by the receiving apparatus 100 via the second communication network.

In one embodiment, the first communication network can be a wired communication network and the second communication network can be a wireless communication network. Here, the generating unit 210 can be configured to generate the data packet such that the type field comprises the first data value when the payload data field of the data packet is not to be transmitted by the receiving apparatus 100 via the wireless communication network. Further, the generating unit 210 can be configured to generate the data packet such that the type field comprises a data value differing from the first data value when the payload data field of the data packet is to be transmitted by the receiving apparatus 100 via the wireless communication network.

According to one embodiment, the generating unit 210 can be configured to generate the data packet such that the type field comprises the first data value when the data packet is a data packet for managing the first communication network. Further, the generating unit 210 can be configured to generate the data packet such that the type field comprises a data value differing from the first data value when the data packet is not a data packet for managing the first communication network.

In one embodiment, the generating unit 210 can be configured to form the type field of the data packet header such that the type field of the data packet header includes exactly one bit. Further, the generating unit 210 can be configured to generate the data packet such that the type field comprises the first data value when the payload data field of the data packet is not to be transmitted by the receiving apparatus 100 via the second communication network. Further, the generating unit 210 can be configured to generate the data packet such that the type field comprises a second data value differing from the first data value when the payload data field of the data packet is not to be transmitted by the receiving apparatus 100 via the second communication network.

According to one embodiment, the generating unit 210 can be configured to form the type field of the data packet header such that the type field of the data packet header includes more than one bit. Here, the generating unit 210 can be configured to generate the data packet such that the type field comprises the first data value when the payload data field of the data packet is not to be transmitted by the receiving apparatus 100 via the second communication network.

Further, the generating unit 210 can be configured to generate the data packet such that the type field comprises one of three or more data values differing from the first data value when the payload data field of the data packet is to be transmitted by the receiving apparatus 100 via the second communication network.

According to one embodiment, the generating unit 210 can be configured to form the data packet such that the data packet includes the payload data field as encrypted payload data field in encrypted form.

In one embodiment, the generating unit 210 can be configured to form the data packet header of the data packet such that the data packet header comprises a media-dependent part and a media-independent part. Here, the generating unit 210 can be configured to form the media-dependent part of the data packet header such that the media-dependent part includes the type field. Further, the generating unit 210 can be configured to form the data packet such that the data packet further includes one or several check bits. Here, the generating unit 210 can be configured to determine the one or several check bits based on the media-independent part of the data packet header of the data packet and based on the payload data field of the data packet but not based on the media-dependent part of the data packet header of the data packet.

In one embodiment, the generating unit 210 can be configured to form the data packet header of the data packet such that the data packet header includes the media-independent part of the data packet header as an encrypted media-independent part of the data packet header in encrypted form.

According to one embodiment, the generating unit 210 can be configured to form the data packet header of the data packet such that the media-independent part of the data packet header of the data packet is a network access layer header of a network access layer of the TCP/IP protocol stack. Or the generating unit 210 can be configured to form the data packet header of the data packet such that the media-independent part of the data packet header of the data packet is a data link layer header of a data link layer of the ISO/OSI model protocol stack.

In one embodiment, the generating unit 210 can be configured to form the data packet header of the data packet such that the media-independent part of the data packet header of the data packet is a data packet header according to IEEE 802.15.4.

According to one embodiment, the generating unit 210 can be configured to form the data packet such that the data packet further comprises a further header which is a header of a physical layer of the ISO/OSI model protocol stack.

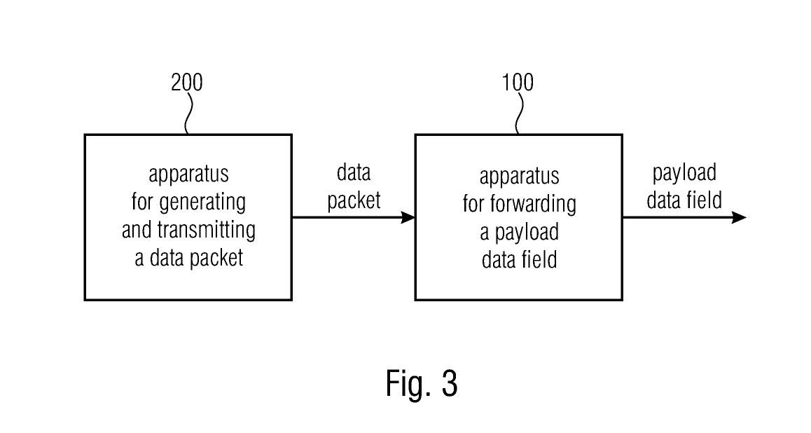

FIG. 3 shows a system for generating and transmitting a data packet via a first communication network and for forwarding a payload data field of the data packet from the first communication network into a second communication network according to an embodiment.

The system includes the above-described apparatus 200 for generating and transmitting a data packet for generating the data packet and the above described apparatus 100 for forwarding a payload data field from a first communication network into a second communication network.

The apparatus 200 for generating and transmitting a data packet is configured to transmit the data packet via the first communication network to the apparatus for forwarding a payload data field from a first communication network into a second communication network.

The apparatus 100 for forwarding a payload data field from a first communication network into a second communication network is configured to receive the data packet from the apparatus 200 for generating and transmitting a data packet. Further, the apparatus 100 for forwarding a payload data field from a first communication network into a second communication network is configured to transmit the payload data field via the second communication network when the type field of a data packet header of the data packet comprises a data value differing from a first data value. Further, the apparatus 100 for forwarding a payload data field from a first communication network into a second communication network is configured to transmit the payload data field not via the second communication network when the type field of the data packet header of the data packet comprises the first data value.

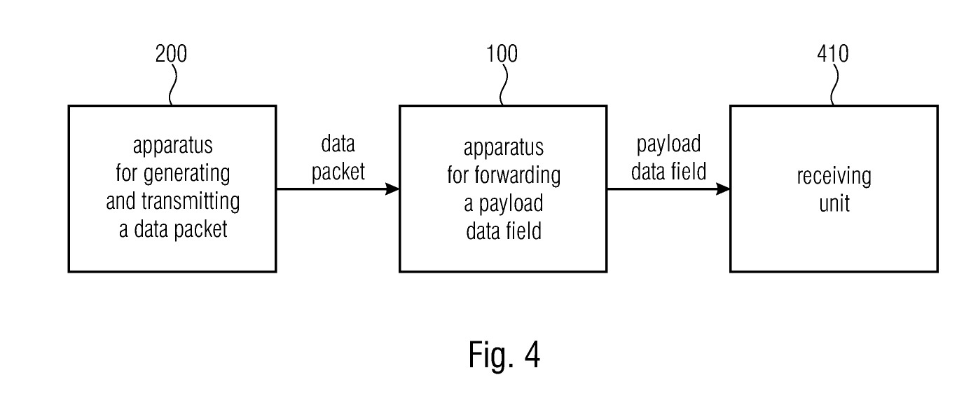

In FIG. 4, the system of FIG. 3 further comprises a receiving unit 410 that is configured to receive the payload data field of the data packet from the apparatus for forwarding a payload data field from a first communication network into a second communication network.

The apparatus 100 for forwarding a payload data field from a first communication network into a second communication network is configured to transmit the payload data field to the receiving unit 410 via the second communication network when the type field of the data packet header of the data packet comprises a data value differing from the first data value.

Further, the apparatus for forwarding a payload data field 100 from a first communication network into a second communication network is configured to not transmit the payload data field to the receiving unit 410 via the second communication network when the type field of the data packet header of the data packet comprises the first data value.

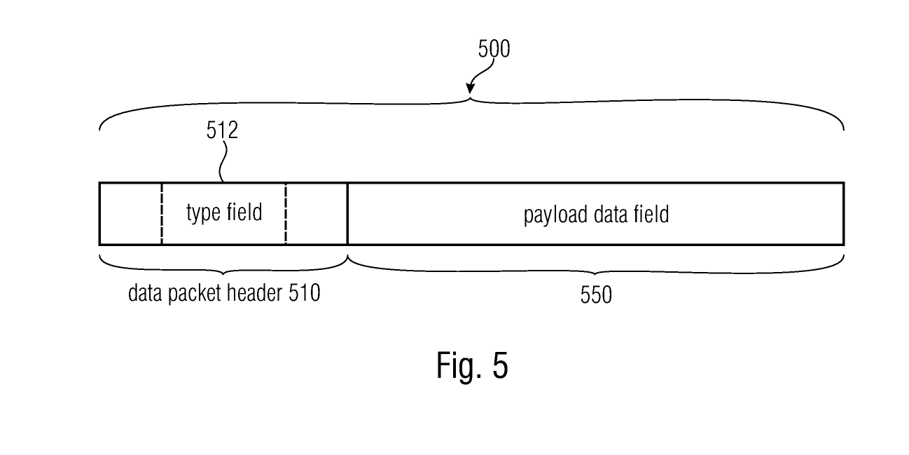

FIG. 5 shows a data packet 500 for transmitting a payload data field via a first communication network to a receiving apparatus. The data packet 500 includes a data packet header 510 and the payload data field 550. The data packet header 510 comprises a type field 512. The type field 512 comprises a first data value when the payload data field 550 of the data packet 500 is not to be transmitted by the receiving apparatus 100 (not shown in FIG. 5) via a second communication network. The type field 512 comprises a data value differing from the first data value when the payload data field 550 of the data packet 500 is to be transmitted by the receiving apparatus 100 via the second communication network.

According to one embodiment, the first communication network can be a wired communication network and the second communication network can be a wireless communication network.

The type field 512 comprises the first data value when the payload data field 550 of the data packet 500 is not to be transmitted by the receiving apparatus 100 via the wireless communication network. Further, the type field 512 comprises a data value differing from the first data value when the payload data field 550 of the data packet 500 is to be transmitted by the receiving apparatus 100 via the wireless communication network.

In one embodiment, the type field 512 comprises the first data value and the data packet 500 is a data packet for managing the first communication network.

According to one embodiment, the type field 512 comprises a data value differing from the first data value and the data packet 500 is no data packet for managing the first communication network.

In one embodiment, the data packet 500 can include the payload data field 500 as an encrypted payload data field in encrypted form.

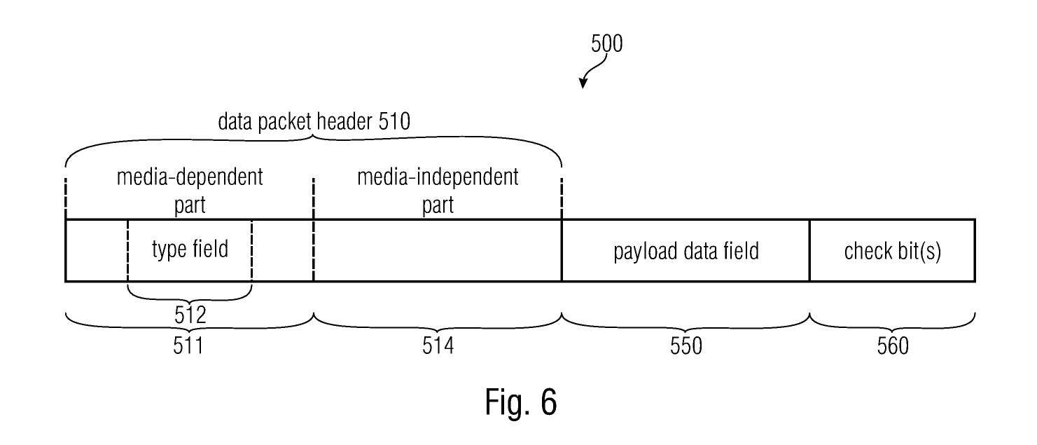

FIG. 6 shows a data packet 500 according to an embodiment.

The data packet header 510 comprises a media-dependent part 511 and a media-independent part 540. Here, the media-dependent part 511 comprises the type field 512.

Further, the data packet 500 comprises one or several check bits 560. Here, the one or several check bits 560 depend on the media-independent part 514 of the data packet header 510 of the data packet 500 and further depend on the payload data field 550 of the data packet 500. However, the check bits 560 do not depend on the media-dependent part 511 of the data packet header 510 of the data packet 500.

According to one embodiment, the data packet header 510 can include the media-independent part 514 as an encrypted media-independent part in encrypted form.

In one embodiment, the media-independent part 540 of the data packet 510 of the data packet 500 can be a network access layer header of a network access layer of the TCP/IP protocol stack. Or the media-independent part 514 of the data packet 510 of the data packet 500 can be a data link layer header of a data link layer of the ISO/OSI model protocol stack.

According to one embodiment, the media-independent part 514 of the data packet header 510 of the data packet 500 can be a data packet header according to IEEE 802.15.4.

Concerning the payload data field 550, it is obvious that the payload data field 550 itself can again include header fields and payload data fields of higher protocol layers.

If, for example the media-independent part 514 of the data packet header 510 is a data link layer header (layer 2 header) of the ISO/OSI model protocol stack, the payload data field 550 includes, for example the header field and the payload data field of the network layer (layer 3) of the ISO/OSI model protocol stack.

Or, for example, when the media-independent part 514 of the data packet header 510 is a network access layer header of the TCP/IP protocol stack, then the payload data field 550 includes, for example, the header field and the payload data field of the IP layer of the IP protocol stack.

The same applies for higher layers of the respective protocol stack.

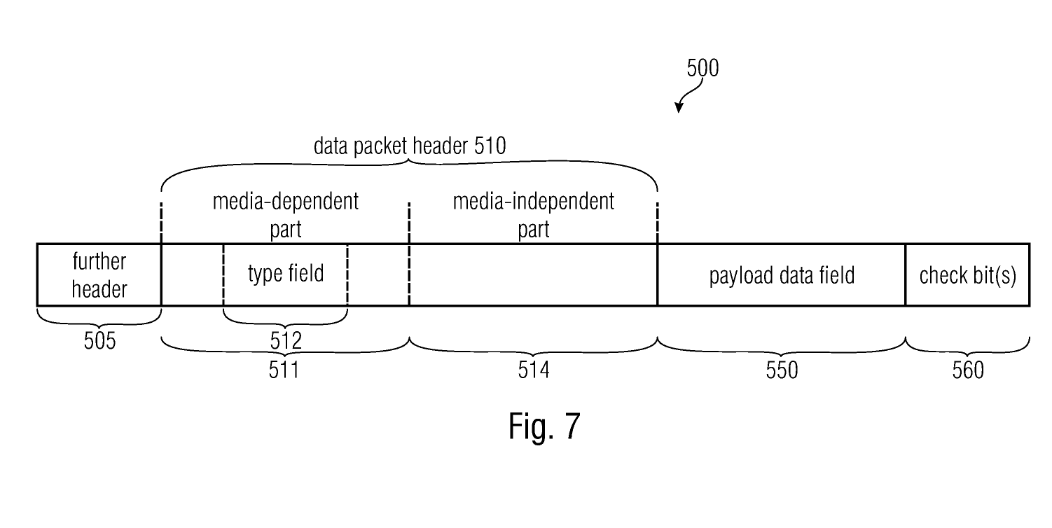

FIG. 7 shows a data packet 500 according to an embodiment which further comprises a further header 505. This further header 505 can be a header of a physical layer of the ISO/OSI model protocol stack.

Embodiments allow the exchange of information between different media without protocol or address conversion. The largest part of the method remains identical as regards to structure and content, only a small media-dependent part of the header has to be adapted.

When changing between wireless and wired network, the header is adapted as follows:

When changing from the wireless network into the wired network, the header of the data link layer is taken over in an unamended manner. The payload data field could also be taken over in an unamended manner, even during encryption. The checksum can also be taken over in an unamended manner provided that the calculation of the checksum starts on the data link layer.

When changing from wired network to the wireless network, merely the information in the media-dependent header are exchanged with the information needed for wireless communication. The media-independent header of the data link layer does not have to be adapted. The payload data field could also be taken over in an unamended manner, even during encryption. The checksum can also be taken over in an unamended manner provided that the calculation of the checksum starts on the data link layer.

Additionally, when changing media from wired to radio and vice versa, the encryption on Layer 2 (MAC layer) between two communication nodes can remain unchanged. Thereby, the advantages of Layer 2 encryption, such as protocol independence and low latency can also be used when changing media.

Particularly advantageous embodiments will be illustrated below:

In order to be able to omit protocol conversion for cross-media communication on the level of the data link layer (OSI model layer 2), a two-part frame structure is used.

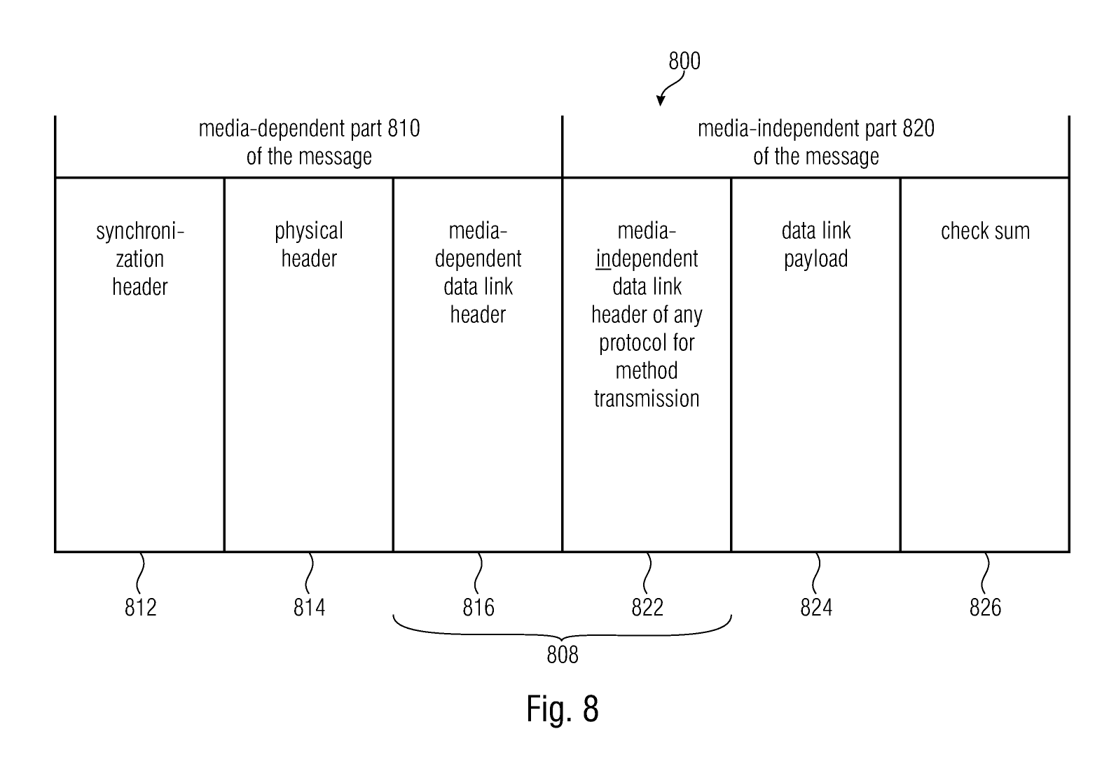

FIG. 8 shows a data packet (frame) 800 according to a further embodiment.

As a media-dependent component 810, the data packet 800 comprises a synchronization header 812, a physical header 814 and a media-dependent data link header 816.

In one embodiment, the media-dependent data link header 816 is used for wired transmission and is not used in wireless transmission.

Further, as a media-independent component 820, the data packet 100 comprises a media-independent data link header 822 of any protocol for message transfer (e.g. IEEE 802.15.4), a data link payload 824 and a checksum 826.

It applies for the media-independent component 820 that, for example, depending on the used radio protocol used for the media-independent component of the message, the structure of the media-independent component of the message can deviate.

The media-dependent data link header 816 and the media-independent data link header 822 together form the data link header 808.

Thus, the first portion of the data packet/frame includes media-dependent message fields 810. The second portion of the frame includes then the media-independent message fields 820.

Depending on the used communication medium (e.g. radio/copper cable/optical waveguide) the media-dependent message fields 810 are adapted. Thus, in the embodiment of FIG. 8, the synchronization header 812 and the physical header 814 as well as the media-dependent data link header 816 are part of the media-dependent message fields 810.

The media-dependent data link header 816 includes, for example, only a single field, the above described type field 512. This type field includes, for example, information concerning the used frame type. Based on the used frame type, it can be determined whether it is a frame for application specific data transmission (e.g. temperature values of a sensor) or a frame for managing the wired network. Frames for application-specific data transmission can be exchanged freely between wireless and wired networks. Frames for managing the wired network are only forwarded within the wired network.

A data link header 822, the data link payload 824 and the checksum 826 are typically part of the media-independent message fields 820. The media-independent frame fields 820 can be identical to the frame fields of any wireless radio transmission protocol as regards to structure, content and order.

One advantage of embodiments with respect to conventional solutions is that communication within the entire network, which can include both wired as well as wireless cross-media communication nodes, is possible without protocol conversion on the data link layer. Protocol and address conversion by a gateway or a bridge as in conventional solutions is not needed. A further advantage is that encryption of the data when the same is performed on MAC or network protocol level (or protocol layers lying above that), can be taken over in an unamended manner. In particular encryption on MAC layer could normally only take place up to the point of the medium change.

In contrary to a conventional solution for medium change (protocol conversion by a gateway), by the omission of address conversion and omission of the necessity for decryption and renewed encryption, advantages result with respect to short latency times and the configuration and management effort is also reduced.

The technical fields of application are manifold.

In particular in the area “Industry 4.0”/“Internet of Things”, there are numerous fields of application for a network that includes both wired as well as wireless cross-media communication nodes without the need for protocol conversion on the data link layer.

Especially in the demand for standardized communication technology based on IPv6, this solution allows continuity of the protocols in order to send and address IP packets without protocol conversion between low power wireless networks via a wired two-wire line directly into IT fiber optic backbones.

For building up a global internet protocol based communication network, the cross-media consistency of the protocols is a large advantage since, apart from the physical interface, both wired as well as wireless nodes can use an almost identical protocol stack.

In one embodiment, a field bus is provided for the Internet of Things (IoT). Thus, applications in the Internet of Things need IP ability in each communication node. Frequently, it is not useful to connect the nodes via Ethernet. In contrary to that, wireless technologies tend to be unreliable.

In embodiments, the Internet of Things bus provides a technology that closes a gap in the Internet of Things communication technology portfolio and at the same time provides IPv6 ability.

Thus, for a new stage of the Internet of Things and the Internet of Energy (IoE), solutions ensuring the universal Internet Protocol (IP) ability especially for the end nodes are needed, wherein simple implementation and universal applicability is to be ensured. With the increasing trend for linkage and digitalization in the energy and industry sector and in Industry 4.0, IP ability in the end node becomes more and more important. Here, in particular the strict requirements of the Internet of Things regarding data rate, range and reliability, flexibility, interoperability (see [1]) and partly security of data are to be fulfilled. Consistency of the protocols and seamless dataflow between different networks is essential for the Internet of Things.

In order to ensure the intended reliability of the data exchange and the control processes, for some fields wired communication is advantageous, in particular in environments with interferences. Wired communication can also realize large ranges without involving the usage of multi hopping technology.

The IoT bus provides a communication protocol combining the advantages of the Internet and the Internet protocols with the advantages of a field bus concerning range, reliability, robustness and low latency. Here, the IoT bus can, for example, be used for wired connection of sensors and actuators wherein network technology is provided for the system components.

In order to be compatible with existing Internet technologies and in order to ensure reliability, power and interoperability, existing standards are integrated, wherein IP communication is realized by means of bus technology.

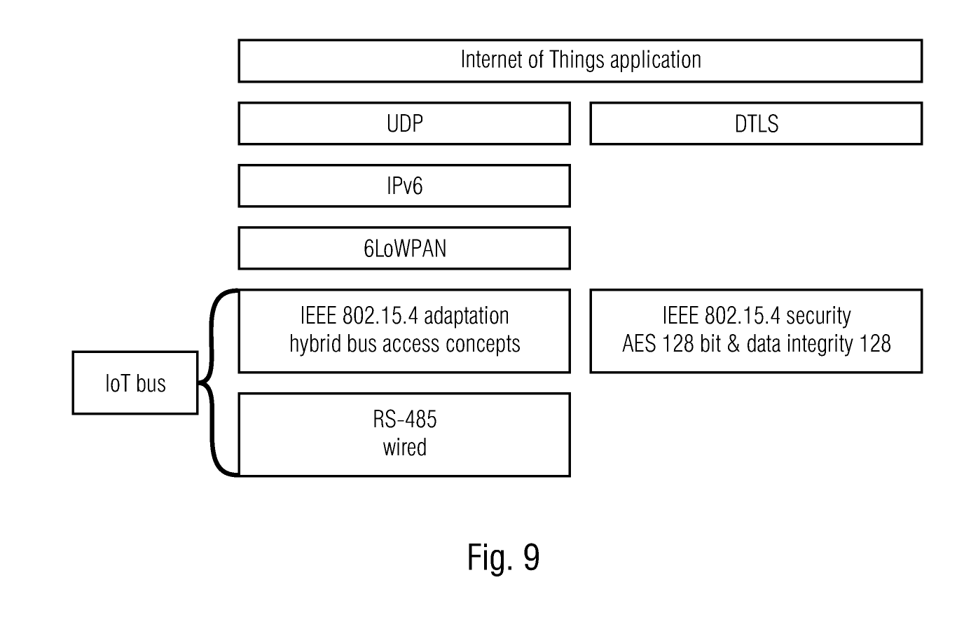

FIG. 9 shows a layer model for an IoT bus according to an embodiment. The IoT bus builds on the IEEE standard 802.15.4 and the IPv6 over low power wireless personal area networks (6LoWPAN).

In order to ensure compatibility with IPv6 (Internet protocol version 6) header compression while at the same time using bus technology, the IEEE standard 802.15.4 protocol has been modified. For this, the medium access control (MAC) protocol header has been supplemented by media access and bus management information. For that, two bus access concepts have been realized, namely a stochastic and deterministic bus access. Both have been combined in a hybrid bus access, wherein timeslot variation has been used. Apart from that, further data packets (frames) for media access control and bus management have been added. The transfer medium has been replaced by a wire-bound communication channel using RS-485 or EIA-485 transceivers, wherein the original IEEE standard 802.15.4 MAC packet/frame structure is maintained.

In embodiments, IPv6 header compression technology is used for realizing IPv6 ability with limited bandwidth. As in other communication technologies based on the IEEE standard 802.15.4, such as a ZigBee IP (see [2]), 6LoWPAN is also used for realizing needed IPv6 ability in limited communication channels (see [3] and [4]). 6LoWPAN has originally been designed to realize IPv6 datagrams across limited wireless connections (see [3]), wherein limited bandwidth, memory or energy resources have been considered by IEEE standard 802.15.4 networks (see [3] and [5]). Here, exchange within the network is realized via the IPv6 protocol.

In embodiments, the UDP (user datagram protocol) is, for example, used as transport layer. On the application layer level, for example, CoAP (constrained application protocol) or MQTT (message queue telemetry transport) or OPC-UA (open platform communications unified architecture) is used.

For IoT applications, reliable and secure communication is needed. The IEEE standard 802.15.4 ensures data integrity by means of signature methods (cryptographic methods). Further, the IEEE standard 802.15.4 supports verification and security measures by checksum methods and data packet confirmations (see [6]). Datagram transport layer security (DTLS) can be used as additional security mechanism (within the data link layer) (see [7]).

By using and adapting the IEEE standard 802.15.4, the IoT bus represents a cross-media communication protocol within the data link layer and combines wireless personal area networks (WPAN) and field busses without needing complex protocol conversion. The consistency of the protocols allows seamless communication by using wired IoT busses as well as wireless commercial radio nodes corresponding to the IEEE standard 802.15.4 without needing an additional gateway.

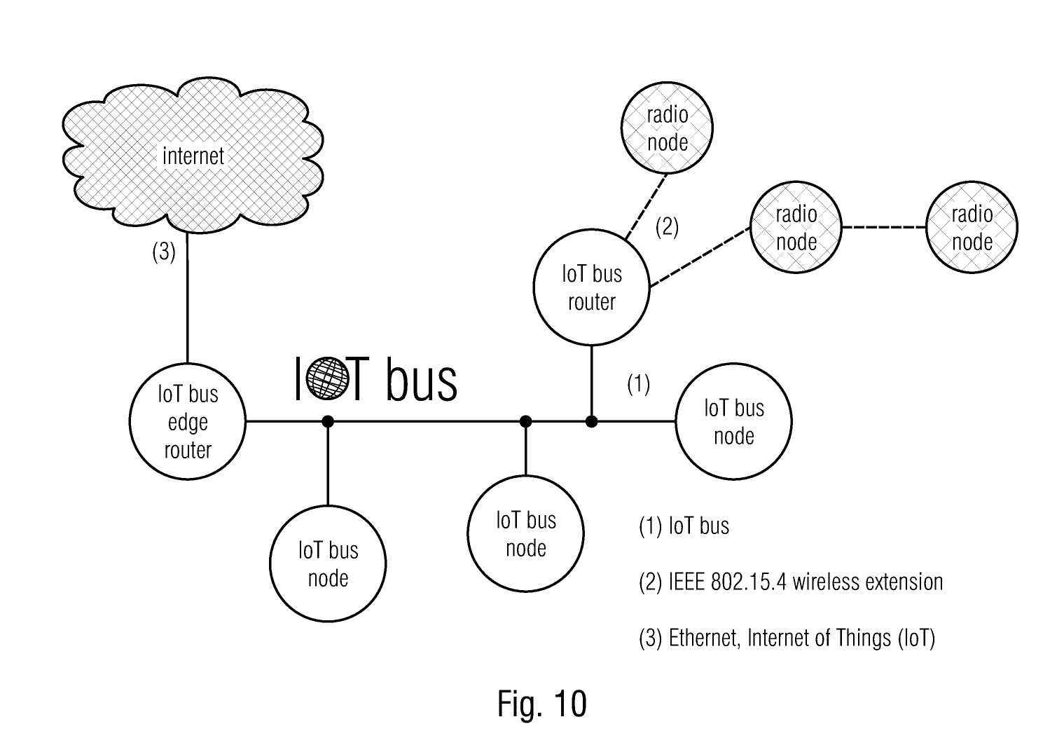

FIG. 10 shows a communication structure according to an embodiment. The communication structure of FIG. 10 includes up to three different segments, namely the actual IoT bus based on the IEEE standard 802.15.4 with an adapted media access concept, an optional wireless extension by IEEE standard 802.15.4 radio nodes and an Internet connection.

The IoT bus can be used, for example within a control system for a direct current distribution network, e.g. for interaction of a control unit with voltage converters, with consumers, with a photovoltaic system and for data exchange.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive methods is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

MCKINSEY GLOBAL INSTITUTE The Internet of Things: Mapping the Value behind the hype, page 21, 2015

[2] ZigBee IP Specification, February 2013.

[3] Ed. J. Hui and P. Thubert. Compression Format for IPv6 Datagrams over IEEE 802.15.4-Based Networks, September 2011.

[4] Jonas Olsson. 6LoWPAN demystified, 2014.

[5] Jonathan W. Hui and David E. Culler. IPv6 in Low-Power Wireless Networks. Proceedings of the IEEE, 98(11):1865-1878, 2010.

[6] David Gascón. Security in 802.15.4 and ZigBee networks, 2009.

[7] E. Rescorla and N. Modadugu. Datagram Transport Layer Security Version 1.2, January 2012.

1. Apparatus for forwarding a payload data field from a first communication network into a second communication network, the apparatus comprising:
a first interface that is configured to receive a data packet from the first communication network, wherein the data packet comprises a data packet header and a payload data field, wherein the data packet header comprises a type field and
a second interface that is configured to transmit the payload data field via the second communication network when the type field comprises a data value differing from a first data value and
wherein the second interface is configured to not transmit the payload data field via the second communication network when the type field comprises the first data value.

2. Apparatus according to claim 1,
wherein the first interface is configured to receive the data packet from the first communication network, wherein the first communication network is a wired communication network and
wherein, when the type field comprises a data value differing from the first data value, the second interface is configured to transmit the payload data field via the second communication network, wherein the second communication network is a wireless communication network and
wherein, when the type field comprises the first data value, the second interface is configured to not transmit the payload data field via the wireless communication network.

3. Apparatus according to claim 1,
wherein, when the type field comprises the first data value, the data packet is a data packet for managing the first communication network and
wherein the second interface is configured to not transmit the data packet via the second communication network when the data packet is a data packet for managing the first communication network.

4. Apparatus according to claim 1,
wherein the type field of the data packet header comprises exactly one bit,
wherein the second interface is configured to transmit the payload data field via the second communication network when the type field comprises a second data value differing from the first data value and
wherein the second interface is configured to not transmit the payload data field via the second communication network when the type field comprises the first data value.

5. Apparatus according to claim 1,
wherein the data packet is a received data packet,
wherein the data packet header of the received data packet comprises a media-dependent part and a media-independent part, wherein the media-dependent part comprises the type field and
wherein, when the type field comprises a data value differing from the first data value, the second interface is configured to form a converted data packet and to transmit the same via the second communication network, wherein the converted data packet comprises the media-independent part of the data packet header of the received data packet and the payload data field of the received data packet but not the media-dependent part of the data packet header of the received data packet.

6. Apparatus according to claim 5, wherein the received data packet further comprises one or several check bits, wherein, when the type field comprises a data value differing from the first data value, the second interface is configured to form the converted data packet such that the converted data packet comprises the one or several check bits of the received data packet as one or several check bits of the converted data packet without changing the value of the one or several check bits in the converted data packet compared to the one or several check bits of the received data packet.

7. Apparatus according to claim 6,
wherein the one or several check bits of the received data packet are one or several received check bits,
wherein the first interface is configured to determine one or several determined check bits, wherein the first interface is configured to determine the one or several determined check bits based on the media-independent part of the data packet header of the received data packet and based on the payload data field of the received data packet but not based on the media-dependent part of the data packet header of the received data packet and
wherein the first interface is configured to compare the one or several determined check bits to the one or several received check bits in order to check the received data packet for errors.

8. Apparatus according to claim 7,
wherein the first interface is configured to transfer the received data packet to the second interface when the one or several received check bits correspond to the one or several determined check bits and
wherein the first interface is configured to not transfer the received data packet to the second interface when the one or several received check bits do not correspond to the one or several determined check bits.

9. Apparatus according to claim 5, wherein the media-independent part of the data packet header of the received data packet is a data packet header according to IEEE 802.15.4 and wherein, when the type field comprises a data value differing from the first data value, the second interface is configured to form the converted data packet such that the converted packet comprises the media-independent part of the data packet header of the received data packet as a data packet header according to IEEE 802.15.4.

10. Apparatus for generating and transmitting a data packet, the apparatus comprising:
a generating unit that is configured to generate the data packet such that the data packet comprises a data packet header and a payload data field, wherein the data packet header comprises a type field and
an interface that is configured to transmit the data packet via a first communication network to a receiving apparatus,
wherein the generating unit is configured to generate the data packet such that the type field comprises a first data value when the payload data field of the data packet is not to be transmitted by the receiving apparatus via a second communication network and
wherein the generating unit is configured to generate the data packet such that the type field comprises a data value differing from the first data value when the payload data field of the data packet is to be transmitted by the receiving apparatus via the second communication network.

11. Apparatus according to claim 10,
wherein the generating unit is configured to generate the data packet such that the type field comprises the first data value when the data packet is a data packet for managing the first communication network and
wherein the generating unit is configured to generate the data packet such that the type field comprises a data value differing from the first data value when the data packet is no data packet for managing the first communication network.

12. Apparatus according to claim 10,
wherein the generating unit is configured to form the type field of the data packet header such that the type field of the data packet header comprises exactly one bit,
wherein the generating unit is configured to generate the data packet such that the type field comprises the first data value when the payload data field of the data packet is not to be transmitted by the receiving apparatus via the second communication network and
wherein the generating unit is configured to generate the data packet such that the type field comprises a second data value differing from the first data value when the payload data field of the data packet is to be transmitted by the receiving apparatus via the second communication network.

13. Apparatus according to claim 10,
wherein the generating unit is configured to form the data packet header of the data packet such that the data packet header comprises a media-dependent part and a media-independent part,
wherein the generating unit is configured to form the media-dependent part of the data packet header such that the media-dependent part comprises the type field and
wherein the generating unit is configured to form the data packet such that the data packet further comprises one or several check bits,
wherein the generating unit is configured to determine the one or several check bits based on the media-independent part of the data packet header of the data packet and based on the payload data field of the data packet but not based on the media-dependent part of the data packet header of the data packet.

14. Apparatus according to claim 13, wherein the generating unit is configured to form the data packet header of the data packet such that the data packet header comprises the media-independent part of the data packet header as an encrypted media-independent part of the data packet header in encrypted form.

15. Apparatus according to claim 13,
wherein the generating unit is configured to form the data packet header of the data packet such that the media-independent part of the data packet header of the data packet is a network access layer header of a network access layer of the TCP/IP protocol stack or
wherein the generating unit is configured to form the data packet header of the data packet such that the media-independent part of the data packet header of the data packet is a data link layer header of a data link layer of the ISO/OSI model protocol stack.

16. Apparatus according to claim 13, wherein the generating unit is configured to form the data packet header of the data packet such that the media-independent part of the data packet header of the data packet is a data packet header according to IEEE 802.15.4.

17. Apparatus according to claim 14,
wherein the generating unit is configured to form the data packet such that the data packet further comprises a further header which is a header of a physical layer of the ISO/OSI model protocol stack.

18. System for generating and transmitting a data packet via a first communication network and for forwarding a payload data field of the data packet from the first communication network into a second communication network, the system comprising:
an apparatus for generating and transmitting a data packet, the apparatus comprising:
a generating unit that is configured to generate the data packet such that the data packet comprises a data packet header and a payload data field, wherein the data packet header comprises a type field and
an interface that is configured to transmit the data packet via a first communication network to a receiving apparatus,
wherein the generating unit is configured to generate the data packet such that the type field comprises a first data value when the payload data field of the data packet is not to be transmitted by the receiving apparatus via a second communication network and
wherein the generating unit is configured to generate the data packet such that the type field comprises a data value differing from the first data value when the payload data field of the data packet is to be transmitted by the receiving apparatus via the second communication network,
for generating the data packet and
an apparatus according to claim 1 for forwarding the payload data field of the data packet via the second communication network,
wherein the apparatus for generating and transmitting a data packet comprising:
a generating unit that is configured to generate the data packet such that the data packet comprises a data packet header and a payload data field, wherein the data packet header comprises a type field and
an interface that is configured to transmit the data packet via a first communication network to a receiving apparatus,
wherein the generating unit is configured to generate the data packet such that the type field comprises a first data value when the payload data field of the data packet is not to be transmitted by the receiving apparatus via a second communication network and
wherein the generating unit is configured to generate the data packet such that the type field comprises a data value differing from the first data value when the payload data field of the data packet is to be transmitted by the receiving apparatus via the second communication network,
is configured to transmit the data packet via the first communication network to the apparatus according claim 1,
wherein the apparatus according to claim 1 is configured to receive the data packet from the apparatus for generating and transmitting a data packet, the apparatus comprising:
a generating unit that is configured to generate the data packet such that the data packet comprises a data packet header and a payload data field, wherein the data packet header comprises a type field and
an interface that is configured to transmit the data packet via a first communication network to a receiving apparatus,
wherein the generating unit is configured to generate the data packet such that the type field comprises a first data value when the payload data field of the data packet is not to be transmitted by the receiving apparatus via a second communication network and
wherein the generating unit is configured to generate the data packet such that the type field comprises a data value differing from the first data value when the payload data field of the data packet is to be transmitted by the receiving apparatus via the second communication network,
wherein the apparatus according to claim 1 is configured to transmit the payload data field via the second communication network when a type field of a data packet header of the data packet comprises a data value differing from a first data value and
wherein the apparatus according to claim 1 is configured to not transmit the payload data field via the second communication network when the type field of the data packet header of the data packet comprises the first data value.

19. Data packet for transmitting a payload data field via a first communication network to a receiving apparatus, the data packet comprising:
a data packet header and
the payload data field,
wherein the data packet header comprises a type field and
wherein the type field comprises a first data value when the payload data field of the data packet is not to be transmitted by the receiving apparatus via a second communication network and
wherein the type field comprises a data value differing from the first data value when the payload data field of the data packet is to be transmitted by the receiving apparatus via the second communication network.

20. Data packet according to claim 19,
wherein the data packet header comprises a media-dependent part and a media-independent part,
wherein the media-dependent part comprises a type field and
wherein the data packet further comprises one or several check bits,
wherein the one or several check bits depend on the media-independent part of the data packet header of the data packet and depend on the payload data field of the data packet but do not depend on the media-dependent part of the data packet header of the data packet.

21. Data packet according to claim 20, wherein the data packet header comprises the media-independent part as an encrypted media-independent part in encrypted form.

22. Method for forwarding a payload data field from a first communication network into a second communication network, the method comprising:
receiving a data packet from the first communication network, wherein the data packet comprises a data packet header and the payload data field, wherein the data packet header comprises a type field,
transmitting the payload data field via the second communication network when the type field comprises a data value differing from a first data value and
no transmitting of the payload data field via the second communication network when the type field comprises the first data value.

23. Method for generating and transmitting a data packet, the method comprising:
generating the data packet such that the data packet comprises a data packet header and a payload data field, wherein the data packet header comprises a type field and
transmitting the data packet via a first communication network to a receiving apparatus,
wherein the data packet is generated such that the type field comprises a first data value when the payload data field of the data packet is not to be transmitted by the receiving apparatus via a second communication network and
wherein the data packet is generated such that the type field comprises a data value differing from the first data value when the payload data field of the data packet is to be transmitted by the receiving apparatus via the second communication network.

24. A non-transitory digital storage medium having a computer program stored thereon to perform the method for forwarding a payload data field from a first communication network into a second communication network, the method comprising:
receiving a data packet from the first communication network, wherein the data packet comprises a data packet header and the payload data field, wherein the data packet header comprises a type field,
transmitting the payload data field via the second communication network when the type field comprises a data value differing from a first data value and
no transmitting of the payload data field via the second communication network when the type field comprises the first data value,
when said computer program is run by a computer.

25. A non-transitory digital storage medium having a computer program stored thereon to perform the method for generating and transmitting a data packet, the method comprising:
generating the data packet such that the data packet comprises a data packet header and a payload data field, wherein the data packet header comprises a type field and
transmitting the data packet via a first communication network to a receiving apparatus,
wherein the data packet is generated such that the type field comprises a first data value when the payload data field of the data packet is not to be transmitted by the receiving apparatus via a second communication network and
wherein the data packet is generated such that the type field comprises a data value differing from the first data value when the payload data field of the data packet is to be transmitted by the receiving apparatus via the second communication network,
when said computer program is run by a computer.
